(19) United States
(12) Patent Application Publication
(10) Pub. No.: US 2014/0091651 A1
(43) Pub. Date: Apr. 3, 2014

(54) ELECTRICAL MACHINE WITH COOLING

(71) Applicant: MAGNA Powertrain AG & Co KG, Lannach (AT)

(72) Inventors: Pirmin Dorfstätter, Gloggnitz (AT); Gerhard PICHLER, St. Stefan ob Stainz (AT); Gereon Johannes PUSCH, Wien (AT); Dominik SCHOBER, Grosskirchheim (AT)

(73) Assignee: MAGNA Powertrain AG & Co KG, Lannach (AT)

(21) Appl. No.: 14/042,613

(22) Filed: Sep. 30, 2013

(30) Foreign Application Priority Data
Sep. 28, 2012 (DE) 10 2012 217 711.6

(51) Int. Cl. H02K 9/00; H02K 9/19

(52) U.S. Cl. CPC H02K 9/005; H02K 9/19
USPC 310/54; 310/58

(57) ABSTRACT

A stator for an electric machine having electrical windings surrounded by a casting compound, and fluid channels for cooling the electrical windings formed in the casting compound in close spatial proximity to the electrical windings.

### CROSS-REFERENCE TO RELATED APPLICATIONS

The present application claims priority 35 U.S.C. §119 to German Patent Publication No. DE 10 2012 217 711.6 (filed on Sep. 28, 2012), which is hereby incorporated by reference in its entirety.

### TECHNICAL FIELD

Embodiments relate to a stator for an electric machine in which the electrical windings of the stator ring are surrounded by a casting compound which contains channels configured to cool the electrical windings.

### BACKGROUND

Generally, in the case of modern electric motors with a compact design, the motor may only dissipate its heat with difficulty. High temperatures reduce the overload capacity and overheating may result in failure of the winding insulation, the bearings, sealing rings and in the case of permanent magnet machines, also in degradation of the magnets.

It is important, therefore, to avoid overheating which takes place as a result of highly efficient removal of heat from the two main heat sources, namely the winding and the laminate stack, of an electric machine. In the related art, two different approaches are pursued for dissipating the heat in the electric machine.

One approach involves achieving direct cooling of the electric winding with oil by the machine rotating directly. Direct contact of the rotor with the highly viscous oil results in churning losses. As an alternative to this approach, liquid cooling systems in the housing of the electric machine are known. The dissipation of heat from the electrical windings in this case takes place indirectly via the laminate stack and the housing.

German Patent Publication DE 10 2011 108 042 A1 discloses a stator for an electric machine. In this laid-open specification, the stator which is produced in a casting compound is provided with a cooling apparatus. In this case, the cooling apparatus is guided as cooling channels along the outer sides of the casting compound. This type of cooling is very indirect, however, since the connection of the windings to the cooling channels is via the electrical insulation material and the stator laminate stack, and the heat may not be dissipated efficiently from the electrical windings.

### SUMMARY

Embodiments also relate to providing cooling for the electrical windings of a stator which efficiently dissipates the heat and is configured for simple integration in a stator.

Advantageously, the stator for the electric machine is formed in such a way that the electrical windings are in close proximity to the channels for the cooling, and thus, the heat may be dissipated effectively.

Due to the formation of cooling channels in the casting compound, the cooling takes place directly at the electrical windings. As a result, the flow of heat away from the critical component parts takes place more quickly and more efficiently since the number of heat transitions between component parts, such as, for example, the housing parts, is reduced. Due to the high degree of integration, the physical space is utilized more effectively and component parts may be reduced. Due to the formation of the cooling channels in the casting compound, said casting compound with the windings forms a closed body, as a result of which sealing measures of the cooling channels with respect to the windings are no longer necessary.

It is advantageous here to use the electrical windings in the form of single-tooth segments. Advantageously, in addition, a cooling channel may be spatially arranged in a region between a single-tooth segment pair.

Due to the fact that the single-tooth segments span a region with an angle α, it is advantageous that the channel has a wedge-shaped cross section.

An advantageous configuration has the cooling channel being configured for connection to cooling regions which extend at least along an end side of the stator ring. As a result, the cooling channels and the cooling regions in the casting compound form a continuous cavity, which may then advantageously also be connected to a cooling system.

In accordance with embodiments, a stator includes at least one of the following: a stator ring; electrical windings; a casting compound surrounding the electric windings; and at least one fluid channel in the casting compound and configured to cool the electrical windings.

In accordance with embodiments, a stator includes at least one of the following: a stator ring; a pair of electrical windings having a space therebetween; a casting compound surrounding the electric windings; and a fluid channel received in the space and configured to cool the electrical windings.

In accordance with embodiments, a stator for an electric machine includes at least one of the following: a stator ring; a plurality of spaced apart first and second electric windings distributed circumferentially over the stator ring, wherein the electrical windings comprise tooth segments; a casting compound surrounding the electric windings; and a fluid channel received in the space between each of the first and second electric windings and configured to cool the first and second electrical windings.

### DRAWINGS

Embodiments will be illustrated by way of example in the drawings and explained in the description below.

FIG. 1 illustrates a stator with a single-tooth winding.

FIG. 2 illustrates a detail of the stator.

FIG. 3 illustrates a fluid body.

FIG. 4 illustrates the configured casting compound.

FIG. 5 illustrates a section through the stator.

### DESCRIPTION

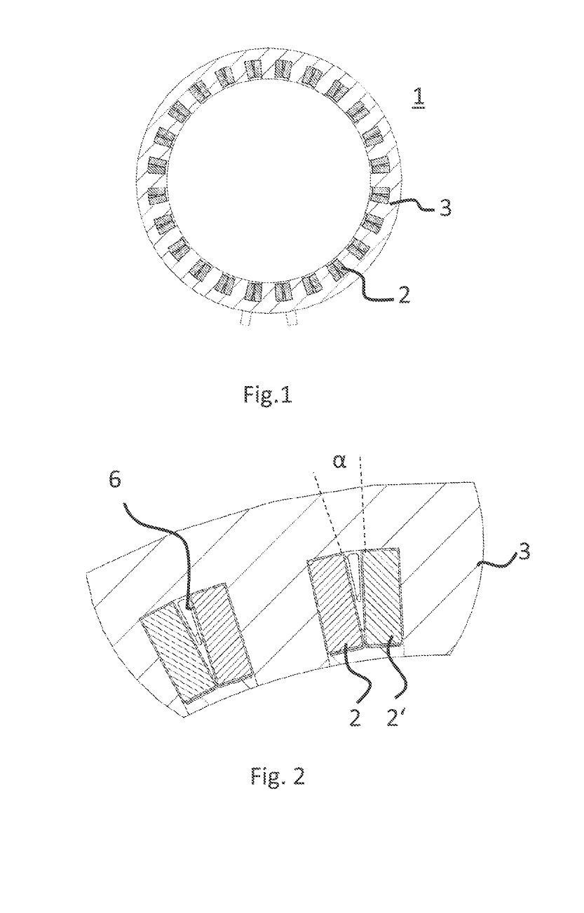

FIG. 1 illustrates a sectional view of a stator ring 1, and FIG. 2 illustrates a detail of the illustration in FIG. 1. A plurality of single-tooth segments 2 are arranged distributed circumferentially in the form of a circle over the stator ring 1. The single-tooth segments 2 are in accordance with embodiments arranged in pairs and have a spatial region between the segments which is spanned by an angle α. A cooling channel 6 is provided at the spatial region between the single-tooth segments 2 and 2′. The cooling channel 6 in this case extends in the form of a wedge in the region between the single-tooth segments 2 and axially with respect to the axis of the stator ring. In this exemplary embodiment, the cooling channel 6 is dimensioned such that it is entirely between the two single-tooth segments. The single-tooth segments 2 and the cooling channels 6 are embedded in a casting compound 3 is configured to fill the spatial region between the single-tooth segments 2, 2′ and insulates the cooling channels 6 from the electrical windings of the single-tooth segments 2. For the production of the cooling channels 6, the casting mould of the stator may be formed in such a way that the hollow spaces for the cooling channels 6 are provided after casting or injection-moulding.

In a further embodiment, the cooling channels 6 may also extend beyond the dimensions of the single-tooth segments into the casting compound 3. In this case, it is merely important that the cooling channels 6 are surrounded by casting compound 3 on all sides. In this way, they may need to be produced in a single injection-moulding method or casting method in a single mould.

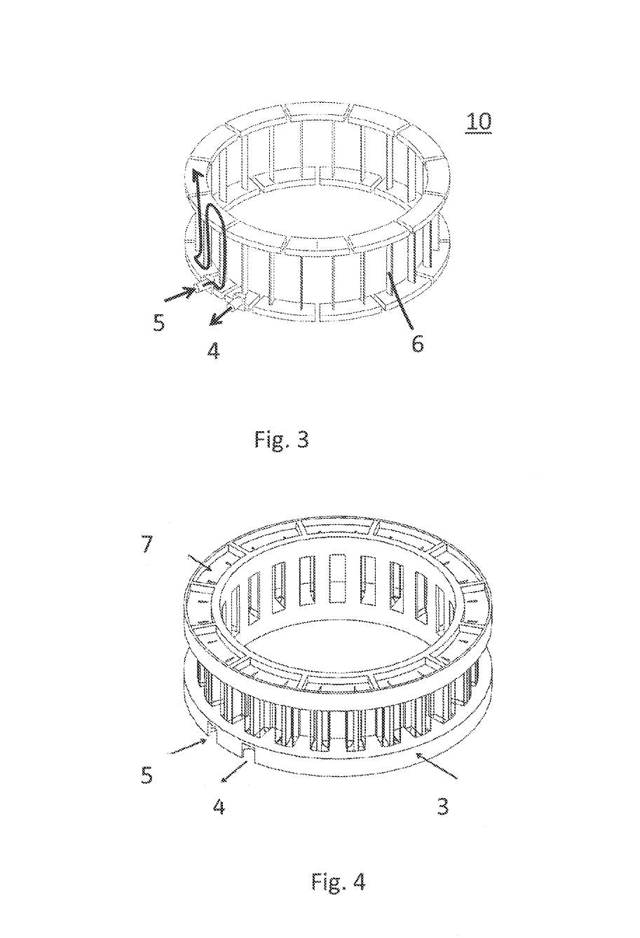

FIG. 3 illustrates, by way of example, a configuration of a fluid body as is formed after a casting compound 3 has been introduced into the mould, i.e., the illustrated mould corresponds to the cavities in a completed stator. The cooling channels 6 are connected to cooling regions 7 in each case at upper and lower regions. The cooling regions 7 extend along at least one end side of the stator. Cooling liquid is introduced into the cavity 10 via a fluid inlet 5 and is distributed along a path corresponding to the sketched arrow in the drawing. The cooling liquid emerges from the cooling cycle via a fluid outlet 4. The cooling cycle may in this case be a dedicated cooling cycle, or the cooling cycle of the stator is connected to the cooling cycle of an internal combustion engine if the electric motor is used in a hybrid vehicle. By virtue of the connection to an already existing cooling cycle of an internal combustion engine, a dedicated cycle ceases to exist.

FIG. 4 illustrates a stator, even if only the casting compound is illustrated. In this case, the cooling channels 6 and the cooling regions 7 are illustrated. Cooling channels and cooling regions form cavities in the casting compound.

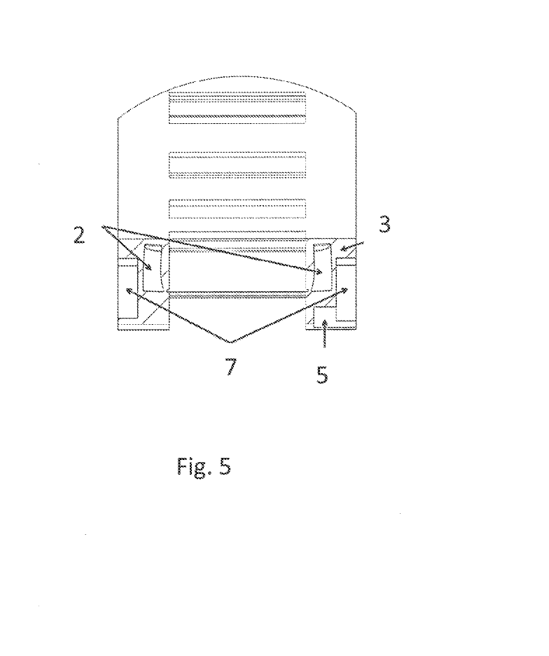

FIG. 5 illustrates a longitudinal section through the stator. This illustration shows that the cooling regions 7 are very close in spatial proximity to the windings of the single-tooth segments 2.

Embodiments are not restricted to a stator having single-tooth segments, and thus, may be applicable to other end windings which are produced by casting with casting compound.

It is merely important that the channels for the cooling of the electrical windings are provided in close spatial proximity to the electrical windings. In accordance with embodiments, “close” relates to cooling channels that are at a spatial distance of a few micrometres from the electrical windings. Then, the cooling channels are only separated from the electrical windings by a thin layer of insulation with a thickness of a few μm, precisely so that the electrical insulation is maintained, but thermal insulation does not effectively take place.

The cooling is particularly efficient since the material of the electrical winding is cooled directly and not indirectly via electrical insulation material, a stator lamination or the housing. The axial throughflow of the cooling liquid takes place directly in the winding and in the casting compound itself and not over the outer circumference of the stator or the casting compound. Heat is dissipated particularly efficiently over the end-side cooling regions since these cooling regions 7 are dimensioned as segments of a circular ring and extend along the entire end face of the stator. A large contact area with the windings is thus provided.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A stator for an electric machine, comprising:
a stator ring;
a plurality of spaced apart first and second electric windings distributed circumferentially over the stator ring, wherein the electrical windings comprise tooth segments;
a casting compound surrounding the electric windings; and
a fluid channel received in the space between each of the first and second electric windings and configured to cool the first and second electrical windings.

2. A stator, comprising
a stator ring;
a plurality of electrical windings;
a casting compound surrounding the electric windings; and
at least one fluid channel in the casting compound and configured to cool the electrical windings.

3. The stator of claim 2, wherein the electrical windings comprise a plurality of tooth segments.

4. The stator of claim 3, wherein the at least one fluid channel for cooling is arranged axially in a space between adjacent tooth segments.

5. The stator of claim 4, wherein the space between the adjacent tooth segments is spanned with an angle into which the at least one fluid channel is received.

6. The stator of claim 5, wherein the at least one fluid channel is wedge-shaped in cross-section.

7. The stator of claim 2, wherein the at least one fluid channel extends at least along one end side of the stator ring.

8. The stator of claim 4, wherein the at least one fluid channel is fluidically connected to a cooling region, which extends at least on one end side of the stator ring.

9. The stator of claim 8, wherein the at least one fluid channel forms, together with the cooling region, a continuous cavity in the casting compound.

10. The stator of claim 9, wherein the continuous cavity is fluidically connected to a cooling system via a fluid inlet and a fluid outlet.

11. The stator of claim 10, wherein the cooling system forms a unit with the cooling system of an internal combustion engine.

12. A stator, comprising:
a stator ring;
a pair of electrical windings having a space therebetween;
a casting compound surrounding the electric windings; and
a fluid channel received in the space and configured to cool the electrical windings.

13. The stator of claim 12, wherein the space between the adjacent tooth segments is spanned with an angle into which the at least one channel is received.

14. The stator of claim 13, wherein the fluid channel is wedge-shaped in cross-section.

15. The stator of claim 12, wherein the fluid channel extends at least along one end side of the stator ring.

16. The stator of claim 12, wherein the fluid channel is fluidically connected to a cooling region, which extends at least on one end side of the stator ring.

17. The stator of claim 16, wherein the fluid channel forms, together with the cooling region, a continuous cavity in the casting compound.

18. The stator of claim 17, wherein the continuous cavity is fluidically connected to a cooling system via a fluid inlet and a fluid outlet.

19. The stator of claim 18, wherein the cooling system forms a unit with the cooling system of an internal combustion engine.
